(19) United States
(12) Patent Application Publication
(10) Pub. No.: US 2024/0286106 A1
(43) Pub. Date: Aug. 29, 2024

(54) APPARATUS FOR DEPOLYMERIZING HYDROCARBON-BASED MATERIAL

(71) Applicant: KOREA INSTITUTE OF MACHINERY & MATERIALS, Daejeon (KR)

(72) Inventors: You-Na KIM, Daejeon (KR); Dae-hoon LEE, Daejeon (KR); Younghoon SONG, Daejeon (KR); Kwan-Tae KIM, Daejeon (KR); Hong Jae KANG, Daejeon (KR); Heesoo LEE, Daejeon (KR); Hohyun SONG, Daejeon (KR)

(21) Appl. No.: 18/573,616

(22) PCT Filed: Jun. 23, 2022
(86) PCT No.: PCT/KR2022/008986

§ 371 Date: Dec. 22, 2023

(30) Foreign Application Priority Data
Jun. 23, 2021 (KR) 10-2021-0081767
Jun. 14, 2022 (KR) 10-2022-0072334

(51) Int. Cl. B01J 19/08; B01J 19/24; B01J 19/26

(52) U.S. Cl. CPC B01J 19/088; B01J 19/245; B01J 19/26; B01J 2219/0869; B01J 2219/0879; B01J 2219/0896

(57) ABSTRACT

An apparatus for depolymerizing a hydrocarbon-based material according to an embodiment of the present disclosure includes a supply unit configured to supply a liquid hydrocarbon, a plasma generation unit configured to generate plasma for supplying thermal energy to the hydrocarbon in the supply unit, a reaction unit provided between the supply unit and the plasma generation unit and configured to convert the liquid hydrocarbon, and a separation unit connected to the reaction unit and configured to separate an unreacted hydrocarbon, a liquid product, and a gaseous product of an aromatic compound that is created by conversion in the reaction unit and introduced.

### TECHNICAL FIELD

The present disclosure relates to an apparatus for depolymerizing a hydrocarbon-based material, and more particularly, to an apparatus for depolymerizing a hydrocarbon-based material, which converts high-boiling point hydrocarbon and separates a product.

### BACKGROUND ART

As known, examples of high-boiling point hydrocarbons include pyrolyzed fuel oil (PFO), naphtha cracking bottom oil (NCB), ethylene cracker bottom oil (EBO), vacuum residue (VR), de-asphalted oil (DAO), atmospheric residue (AR), fluid catalytic cracking decant oil (FCC-DO), residue fluid catalytic cracking decant oil (RFCC-DO), heavy aromatic oil, and the like that have boiling points of 120° C. or more.

The high-boiling point hydrocarbon is obtained as an essential by-product produced from a petroleum refining process. The high-boiling point hydrocarbon is mostly used as fuel for ships or power generation facilities because the high-boiling point hydrocarbon is low in cost due to low utilization value.

However, the high-boiling point hydrocarbon contains a large amount of useful and high-value usable aromatic compounds (BTX). Therefore, studies are being actively conducted to utilize the high-boiling point hydrocarbon. However, because of physicochemical properties of the high-boiling point hydrocarbon compound, it is difficult to supply and handle reactants, control reaction conditions such as a reaction time and a temperature, and obtain high-selectivity products because of a variety of components. That is, during a hydrocarbon decomposition reaction, the selectivity of the product is significantly affected by a reaction temperature, a time, and a pressure.

In order to produce useful chemical materials such as aromatic compounds (BTX), i.e., benzene, toluene, and xylene from the high-boiling point hydrocarbon, there is a need for a reactor to control a plasma generation unit and transfer thermal energy, which is produced by generated plasma, to the high-boiling point hydrocarbon.

### DISCLOSURE

### Technical Problem

The present disclosure attempts to provide an apparatus for depolymerizing a hydrocarbon-based material, which is capable of converting high-boiling point hydrocarbons into useful chemical materials. The present disclosure attempts to provide an apparatus for depolymerizing a hydrocarbon-based material, which is capable of effectively transferring thermal energy, which is produced by plasma generated by controlling a plasma generation unit, to liquid hydrocarbons.

### Technical Solution

An apparatus for depolymerizing a hydrocarbon-based material according to an embodiment of the present disclosure includes a supply unit configured to supply a liquid hydrocarbon, a plasma generation unit configured to generate plasma for supplying thermal energy to the hydrocarbon in the supply unit, a reaction unit provided between the supply unit and the plasma generation unit and configured to primarily convert the liquid hydrocarbon, and a separation unit connected to the reaction unit and configured to separate an unreacted hydrocarbon, a liquid product, and a gaseous product of an aromatic compound that is created by primary conversion in the reaction unit and introduced.

The plasma generation unit may generate arc plasma having a preset temperature range by using hydrogen or a hydrogen-containing gas mixture as a discharge gas.

The plasma generation unit may further include a discharge port configured to discharge a plasma jet to the reaction unit and having a small inner diameter, and a high-temperature part connected to the discharge port and having an inner diameter that is larger than the inner diameter of the discharge port and decreases toward the discharge port, and the plasma jet discharged from the discharge port may be discharged into the reaction unit.

The reaction unit may separate and connect the plasma generation unit and the supply unit.

The reaction unit may include a downward-inclined surface disposed at a side adjacent to the plasma generation unit and configured to define a space having a narrow upper side directed toward the plasma generation unit, and a wide lower side.

The reaction unit may further include an upward-inclined surface disposed at a side adjacent to the supply unit and configured to define a space having a narrow lower side directed toward the supply unit, and a wide upper side.

An inner diameter of the supply unit may be equal to an inner diameter of a lower end of the upward-inclined surface.

The separation unit may include a single chamber or a plurality of chambers connected to the reaction unit and configured to be supplied with the converted hydrocarbon.

The chamber may include: a first discharge port provided at an upper side thereof and configured to discharge the gaseous product; and a second discharge port provided at a lower side thereof and configured to discharge the liquid product.

The second discharge port may be connected to the supply unit through a circulation line.

The aromatic compound created by being primarily converted in the separation unit may include at least one of benzene, toluene, xylene, and an organic solvent having a carbon number of 15 or less.

The apparatus for depolymerizing a hydrocarbon-based material according to the embodiment of the present disclosure may further include a catalyst reaction unit connected to the separation unit and configured to create light olefin by additionally converting a liquid product and an unreacted hydrocarbon that are separated by the separation unit and have a small molecular weight.

The reaction unit may include a downward-inclined surface disposed at a side adjacent to the plasma generation unit and configured to define a space having a narrow upper side directed toward the plasma generation unit, and a wide lower side, and a lower end directed toward the separation unit may be connected to a neck portion having a smaller inner diameter than the reaction unit in order to define a high-temperature reaction space in which a flow temporarily stays.

The supply unit may include at least one injection nozzle provided on the downward-inclined surface and configured to inject a liquid hydrocarbon into the reaction unit.

The injection nozzle may be provided as a pair of injection nozzles, and injection centerlines of the pair of injection nozzles may deviate from a center of a planar cross-section of the reaction unit and are positioned in parallel with each other.

The separation unit may be connected to the reaction unit through the neck portion, the separation unit may have a first discharge port provided at an upper side thereof and configured to discharge the gaseous product, and the separation unit may have a second discharge port provided at a lower side thereof and configured to discharge the liquid product.

The second discharge port may be connected to the supply unit through a circulation line.

The separation unit may be connected to the reaction unit through the neck portion, and the separation unit may have a solvent nozzle provided at one side thereof to inject a solvent toward an inner surface of the separation unit, and a discharge port disposed at a lowermost side and configured to discharge the liquid product.

The separation unit may further include a discharge port provided below the solvent nozzle and configured to discharge the gaseous product, and the discharge port configured to discharge the liquid product may be connected to the supply unit through a circulation line.

### Advantageous Effect

According to the embodiment of the present disclosure, the supply unit and the plasma generation unit are separated from each other and connected to each other through the reaction unit, which makes it possible to effectively transfer thermal energy, which is generated by plasma generated under the control of the plasma generation unit, to the liquid hydrocarbon at the time of converting the supplied liquid high-boiling point hydrocarbon into the useful chemical materials.

### DESCRIPTION OF THE DRAWINGS

FIG. 1 is a configuration view of an apparatus for depolymerizing a hydrocarbon-based material according to a first embodiment of the present disclosure.

FIG. 2 is a configuration view of an apparatus for depolymerizing a hydrocarbon-based material according to a second embodiment of the present disclosure.

FIG. 3 is a configuration view of an apparatus for depolymerizing a hydrocarbon-based material according to a third embodiment of the present disclosure.

FIG. 4 is a top plan view illustrating a state in which an injection nozzle applied to FIG. 3 injects liquid hydrocarbons into a reaction unit.

FIG. 5 is a configuration view of an apparatus for depolymerizing a hydrocarbon-based material according to a fourth embodiment of the present disclosure.

### MODE FOR INVENTION

Hereinafter, embodiments of the present disclosure will be described in detail with reference to the accompanying drawings so that those with ordinary skill in the art to which the present disclosure pertains may easily carry out the embodiments. However, the present disclosure may be implemented in various different ways and is not limited to the embodiments described herein. In the drawings, a part irrelevant to the description will be omitted to clearly describe the present disclosure, and the same or similar constituent elements will be designated by the same reference numerals throughout the specification.

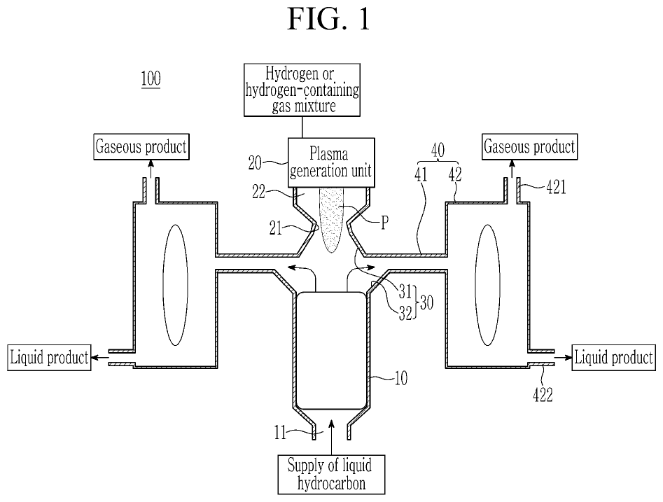

FIG. 1 is a configuration view of an apparatus for depolymerizing a hydrocarbon-based material according to a first embodiment of the present disclosure. With reference to FIG. 1, an apparatus 100 for depolymerizing a hydrocarbon-based material according to a first embodiment includes a supply unit 10, a plasma generation unit 20, a reaction unit 30, and a separation unit 40. The depolymerization apparatus 100 is configured to implement high-value-added hydrocarbon-based materials with a high-boiling point. The high boiling point is a boiling point of 120° C. or more.

The supply unit 10 is configured to supply liquid high-boiling point hydrocarbons. For example, the supply unit 10 is supplied with the liquid hydrocarbon through a supply port 11 provided at a lower side of the supply unit 10. In addition, the supply unit 10 is formed in a cylindrical shape and filled with the liquid hydrocarbon. The supply unit 10 supplies the liquid hydrocarbon, which is supplied from the lower side, by pushing the liquid hydrocarbon upward. The plasma generation unit 20 is configured to generate plasma P to supply thermal energy directly to the liquid hydrocarbon that fills the supply unit 10. The plasma generation unit 20 generates arc plasma having a preset temperature range by supplying hydrogen or a hydrogen-containing gas mixture as a discharge gas.

For example, the plasma generation unit 20 further includes a discharge port 21 configured to discharge a plasma jet to the reaction unit 30 and having a small inner diameter, and a high-temperature part 22 connected to the discharge port 21 and having an inner diameter that is larger than the inner diameter of the discharge port 21 and decreases toward the discharge port 21. Therefore, the high-temperature part 22 delays a discharge of heat and plasma P from the plasma generation unit 20 to the reaction unit 30, such that the high-temperature part 22 may generate high-temperature heat and supply the high-temperature heat to the reaction unit 30.

The reaction unit 30 is provided between the supply unit 10 and the plasma generation unit 20 and configured to convert the liquid hydrocarbon. That, the reaction unit 30 separates and connects the plasma generation unit 20 and the supply unit 10. The high-boiling point hydrocarbon reacts to be converted in the reaction unit 30. That is, the liquid hydrocarbon reacts with active hydrogen or hydrogen and heat generated by the high-temperature plasma in the reaction unit 30.

The reaction unit 30 primarily provides a space for a conversion reaction of the liquid hydrocarbon. The reaction unit 30 may separate the supply unit 10 and the plasma generation unit 20 and primarily define the primary conversion reaction space, thereby suppressing carbon generation, which may occur when the high-boiling point hydrocarbon comes into direct contact with the plasma, and establishing a stable reaction condition.

The high-boiling point hydrocarbon may contaminate the inside of the depolymerization apparatus 100, i.e., the inside of the reaction unit 30 or cause an unstable discharge of the plasma generation unit 20. However, because the reaction unit 30 separates the supply unit 10 and the plasma generation unit 20, the overall stability of the depolymerization apparatus 100 may be ensured. In addition, the depolymerization apparatus 100 may improve the selectivity of the product and improve the conversion rate of the product by controlling a reaction temperature, time, and area.

The reaction unit 30 includes a downward-inclined surface 31 and an-upward inclined surface 32 that face each other and are connected to each other. The downward-inclined surface 31 is disposed at a side adjacent to the plasma generation unit 20 and defines a space having a narrow upper side and a wide lower side. The upward-inclined surface 32 is disposed at a side adjacent to the supply unit 10 and defines a wide space having a lower side having the same inner diameter as the supply unit 10, and an upper side having a larger inner diameter than the supply unit 10. An inner diameter of the supply unit 10 is equal to an inner diameter of a lower end of the upward-inclined surface 32.

The downward-inclined surface 31 and the upward-inclined surface 32 may minimize the deposition of the hydrocarbon in the reaction unit 30 even though the primary conversion reaction is performed in the reaction unit 30. That is, a liquid product in the reaction unit 30 comes into contact with the downward-inclined surface 31 and the upward-inclined surface 32, flows downward, and enters the liquid hydrocarbon in the supply unit 10 again, which may minimize the deposition of the hydrocarbon on the inner surface of the reaction unit 30.

The high-temperature heat, which is consistently supplied from the high-temperature part 22, performs the primary conversion reaction while staying on the surface of the liquid hydrocarbon in the supply unit 10. The plasma generation unit 20 may control a drive voltage to bring a plasma P jet, which passes through the high-temperature part 22, into contact with the surface of the liquid hydrocarbon, thereby directly inducing the primary conversion reaction of the plasma P jet.

The product, which is converted from the high-boiling point hydrocarbon by the primary reaction in the reaction unit 30, has a its own high-added value and contains benzene, toluene, xylene, and organic solvent that are easy to use.

The separation unit 40 is connected to the reaction unit 30 and configured to separate gaseous products, liquid products, and unreacted hydrocarbons of aromatic compounds that are produced by the primary conversion in the reaction unit 30 and introduced. For example, the separation unit 40 may be configured as a single chamber or a plurality of chambers 42 connected to the downward-inclined surface 31 and the upward-inclined surface 32 by means of a connection pipe 41. The plurality of chambers 42 may improve the conversion performance of the plasma generation unit 20 and maximize the conversion capacity.

The chamber 42 has a first discharge port 421 provided at an upper side thereof to discharge a gaseous product, and a second discharge port 422 provided at a lower side thereof to discharge a liquid product. The connection pipe 41 is disposed between the first discharge port 421 and the second discharge port 422 and connected to the chamber 42, such that the gaseous product and the liquid product may be quickly discharged to the first and second discharge ports 421 and 422, respectively.

Hereinafter, various exemplary embodiments of the present invention will be described. The description of the components identical to the components of the first embodiment and the above-mentioned embodiments will be omitted, and different components will be described.

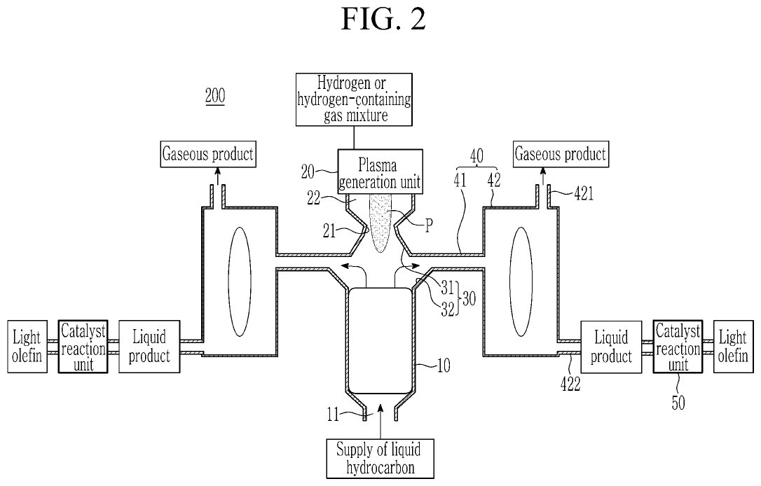

FIG. 2 is a configuration view of an apparatus for depolymerizing a hydrocarbon-based material according to a second embodiment of the present disclosure. With reference to FIG. 2, a depolymerization apparatus 200 of the second embodiment further includes catalyst reaction units 50.

The catalyst reaction unit 50 is connected to the separation unit 40 and configured to create and discharge light olefin, which is a high-value compound, by secondarily converting the liquid product and unreacted hydrocarbon that are separated from the gaseous product in the separation unit 40 and have a small molecular weight.

Therefore, the catalyst reaction unit 50 may increase a conversion rate of the unreacted material or improve the selectivity of the product. The catalyst reaction unit 50 may be configured to adjust a temperature and control a catalyst reaction temperature, as necessary. That is, the catalyst reaction unit 50 may control the catalyst reaction temperature depending on the selection of the product.

In addition, in the catalyst reaction unit 50, a catalyst may be deactivated by coke generated during a catalyst reaction. In this case, although not illustrated, the catalyst may be regenerated and reused by converting the coke on the catalyst into methane by supplying hydrogen, which is supplied to the plasma reaction unit, to the catalyst reaction unit, or the catalyst may be regenerated and reused by combusting the coke on the catalyst by supplying oxygen.

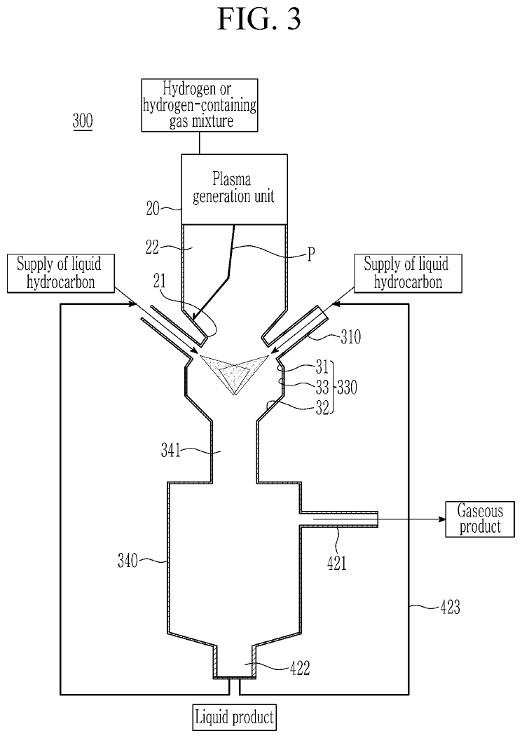

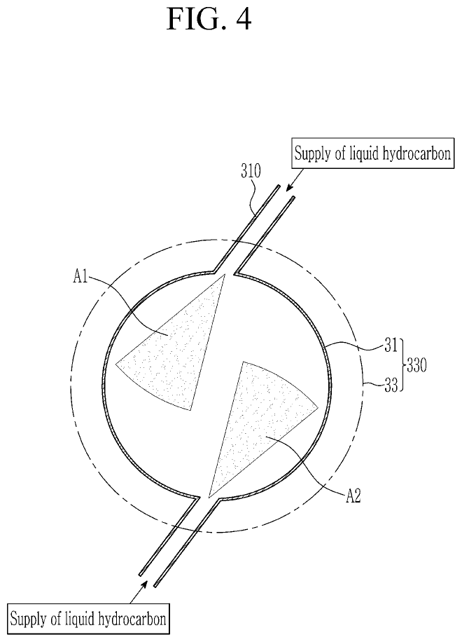

FIG. 3 is a configuration view of an apparatus for depolymerizing a hydrocarbon-based material according to a third embodiment of the present disclosure, and FIG. 4 is a top plan view illustrating a state in which an injection nozzle applied to FIG. 3 injects a liquid hydrocarbon into a reaction unit.

With reference to FIGS. 3 and 4, a reaction unit 330 of a depolymerization apparatus 300 of the third embodiment includes a downward-inclined surface 31, a cylindrical surface 33, and an upward-inclined surface 32. The downward-inclined surface 31 is disposed at a side adjacent to the plasma generation unit 20 and defines a space having a narrow upper side and a wide lower side. The cylindrical surface 33 is connected to a lower end of the downward-inclined surface 31 and defines a cylindrical space. At a side adjacent to a separation unit 340, the upward-inclined surface 32 defines a wide space having a lower side connected to a neck portion 341 having a smaller inner diameter than the reaction unit 330, and an upper side having the same inner diameter as the cylindrical surface 33.

A supply unit 310 includes at least one injection nozzle provided on the downward-inclined surface 31 and configured to inject the liquid hydrocarbon into the reaction unit 330. For example, the injection nozzle may be provided as a pair of injection nozzles. Injection centerlines of the pair of injection nozzles may deviate from a center of the reaction unit 330 on a planar cross-section (see FIG. 4) of the reaction unit 330 and be positioned in parallel with each other. Alternatively, the injection nozzles inject the liquid hydrocarbon in directions tangential to the downward-inclined surface 31 and the cylindrical surface 33 (directions parallel to tangential lines) toward different regions A1 and A2 on the planar cross-section (see FIG. 4) of the reaction unit 330 and injects the liquid hydrocarbon in a direction inclined downward with respect to the cylindrical surface 33 on a longitudinal section (see FIG. 3) of the reaction unit 330.

The injection nozzles of the supply unit 310 supplies the high-boiling point hydrocarbon into the reaction unit 330 and directly induces the primary conversion reaction in the reaction unit 330. The injection nozzle may control the atomization of the liquid hydrocarbon, positioning, and primary conversion reaction time, thereby minimizing the deposition of the hydrocarbon in the reaction unit 330.

Because the injection nozzles are directed toward the different regions A1 and A2, the injection nozzles may cover different spaces in the reaction unit 330, thereby uniformly supplying the liquid hydrocarbon while preventing the liquid hydrocarbon from being concentrated in a partial region in the reaction unit 330. Because the injection nozzles are directed in the directions tangential to the downward-inclined surface 31 and the cylindrical surface 33 and directed in the direction inclined downward with respect to the cylindrical surface 33, the injected liquid hydrocarbon may sweep downward the coke accumulated on the downward-inclined surface 31 and the cylindrical surface 33. That is, it is possible to prevent a solid product from being deposited in the reaction unit 330.

The upward-inclined surface 32 defines a conical structure. Therefore, in case that a liquid reactant and a gaseous reactant are discharged to the neck portion 341 from the reaction unit 330, the upward-inclined surface 32 may prevent a blocking phenomenon caused by the liquid product and the solid by-product.

The separation unit 340 is connected to the reaction unit 330 through the neck portion 341 and includes the first discharge port 421 and the second discharge port 422. The first discharge port 421 is provided at an upper side of the separation unit 340 and discharges the gaseous product. The second discharge port 422 is provided at a lower side of the separation unit 340 and discharges the liquid product.

In addition, the second discharge port 422 is connected to the supply unit 310 through a circulation line 423. Therefore, the liquid product and the unreacted liquid hydrocarbon, which are separated from the separation unit 340, are circulated and supplied to the supply unit 310 through the circulation line 423 and perform the conversion reaction again in the reaction unit 330.

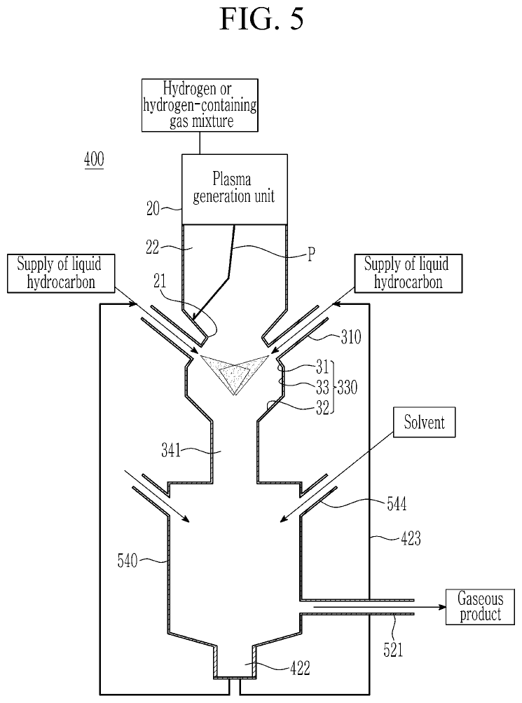

FIG. 5 is a configuration view of an apparatus for depolymerizing a hydrocarbon-based material according to a fourth embodiment of the present disclosure. With reference to FIG. 5, a separation unit 440 of a depolymerization apparatus 400 of the fourth embodiment is connected to the reaction unit 330 through the neck portion 341 and includes a solvent nozzle 544, a first discharge port 521, and the second discharge port 422.

The solvent nozzle 544 is provided at an uppermost side to inject a solvent toward an inner surface of a separation unit 540. The solvent nozzle 544 is provided at a rear end of the reaction unit 330 and injects a solvent, thereby preventing an increase in viscosity of the liquid product caused by plasma discharge, a liquid hydrocarbon flow rate, and gaseous reactants and products. That is, it is possible to prevent plugging that may be caused by an increase in viscosity of the liquid product. In addition, it is possible to prevent the solid product from being deposited in the separation unit 340 and the reaction unit 330.

The first discharge port 521 is provided below the solvent nozzle 544 of the separation unit 540 and discharges the gaseous product. The first discharge port 521 may be installed at a position at which the first discharge port 521 does not hinder the installation of the solvent nozzle 544 and the injection of the solvent.

The second discharge port 422 is provided at a lowermost side of the separation unit 540 and discharges the liquid product. The solid, liquid, and gaseous products are separated at the lower side of the separation unit 540 and separated and discharged to the first and second discharge ports 521 and 422.

The second discharge port 422 is connected to the supply unit 310 through the circulation line 423. The liquid and solid products are recirculated and supplied to the supply unit 310 through the circulation line 423 and perform the conversion reaction again in the reaction unit 330.

While the exemplary embodiments of the present disclosure have been described above, the present disclosure is not limited thereto, and various modifications can be made and carried out within the scope of the claims, the detailed description of the present disclosure, and the accompanying drawings, and also fall within the scope of the present disclosure.

### DESCRIPTION OF REFERENCE NUMERALS

| | |
|---|---|
| 10, 310: Supply unit | 11: Supply port |
| 20: Plasma generation unit | 21: Discharge port |
| 22: High-temperature part | 30, 330: Reaction unit |
| 31: Downward-inclined surface | 32: Upward-inclined surface |
| 40, 340, 440, 540: Separation | 41: Connection pipe |
| unit | |
| 42: Chamber | 50: Catalyst reaction unit |
| 33: Cylindrical surface | 100, 200, 300, 400: Depolymerization |
| | apparatus |
| 341: Neck portion | 421, 521: First discharge port |
| 422: Second discharge port | 423: Circulation line |
| 544: Solvent nozzle | A1, A2: Different regions |
| P: Plasma | |

1. An apparatus for depolymerizing a hydrocarbon-based material, the apparatus comprising:
a supply unit configured to supply a liquid hydrocarbon;
a plasma generation unit configured to generate plasma for supplying thermal energy to the hydrocarbon in the supply unit;
a reaction unit provided between the supply unit and the plasma generation unit and configured to convert the liquid hydrocarbon; and
a separation unit connected to the reaction unit and configured to separate an unreacted hydrocarbon, a liquid product, and a gaseous product of an aromatic compound that is created by conversion in the reaction unit and introduced.

2. The apparatus of claim 1, wherein:
the plasma generation unit generates arc plasma having a preset temperature range by using hydrogen or a hydrogen-containing gas mixture as a discharge gas.

3. The apparatus of claim 1, wherein:
the plasma generation unit comprises a discharge port configured to discharge a plasma jet to the reaction unit and having a small inner diameter, and a high-temperature part connected to the discharge port and having an inner diameter that is larger than the inner diameter of the discharge port and decreases toward the discharge port, and
the plasma jet discharged from the discharge port is discharged into the reaction unit.

4. The apparatus of claim 1, wherein:
the reaction unit separates and connects the plasma generation unit and the supply unit.

5. The apparatus of claim 1, wherein:
the reaction unit includes a downward-inclined surface disposed at a side adjacent to the plasma generation unit and configured to define a space having a narrow upper side directed toward the plasma generation unit, and a wide lower side.

6. The apparatus of claim 5, wherein:
the reaction unit further includes an upward-inclined surface disposed at a side adjacent to the supply unit and configured to define a space having a narrow lower side directed toward the supply unit, and a wide upper side.

7. The apparatus of claim 6, wherein:
an inner diameter of the supply unit is equal to an inner diameter of a lower end of the upward-inclined surface.

8. The apparatus of claim 6, wherein:
the separation unit includes a single chamber or a plurality of chambers connected to the reaction unit and configured to be supplied with the converted hydrocarbon.

9. The apparatus of claim 8, wherein:
the chamber comprises:
a first discharge port provided at an upper side thereof and configured to discharge the gaseous product; and
a second discharge port provided at a lower side thereof and configured to discharge the liquid product.

10. The apparatus of claim 9, wherein:
the second discharge port is connected to the supply unit through a circulation line.

11. The apparatus of claim 1, wherein:
the aromatic compound created by being converted in the separation unit includes at least one of benzene, toluene, xylene, and an organic solvent having a carbon number of 15 or less.

12. The apparatus of claim 1, further comprising:
a catalyst reaction unit connected to the separation unit and configured to create light olefin by additionally converting a liquid product and an unreacted hydrocarbon that are separated by the separation unit and have a small molecular weight.

13. The apparatus of claim 1, wherein:
the reaction unit includes a downward-inclined surface disposed at a side adjacent to the plasma generation unit and configured to define a space having a narrow upper side directed toward the plasma generation unit, and a wide lower side, and
a lower end directed toward the separation unit is connected to a neck portion having a smaller inner diameter than the reaction unit in order to define a high-temperature reaction space in which a flow temporarily stays.

14. The apparatus of claim 13, wherein:
the supply unit comprises at least one injection nozzle provided on the downward-inclined surface and configured to inject a liquid hydrocarbon into the reaction unit.

15. The apparatus of claim 14, wherein:
the injection nozzle is provided as a pair of injection nozzles, and
injection centerlines of the pair of injection nozzles deviate from a center of a planar cross-section of the reaction unit and are positioned in parallel with each other.

16. The apparatus of claim 13, wherein:
the separation unit is connected to the reaction unit through the neck portion,
the separation unit has a first discharge port provided at an upper side thereof and configured to discharge the gaseous product, and
the separation unit has a second discharge port provided at a lower side thereof and configured to discharge the liquid product.

17. The apparatus of claim 16, wherein:
the second discharge port is connected to the supply unit through a circulation line.

18. The apparatus of claim 13, wherein:
the separation unit is connected to the reaction unit through the neck portion, and
the separation unit has a solvent nozzle provided at one side thereof to inject a solvent toward an inner surface of the separation unit, and a discharge port disposed at a lowermost side and configured to discharge the liquid product.

19. The apparatus of claim 18, wherein:
the separation unit further comprises a discharge port provided below the solvent nozzle and configured to discharge the gaseous product, and
the discharge port configured to discharge the liquid product is connected to the supply unit through a circulation line.
